(19) United States
(12) Patent Application Publication
(10) Pub. No.: US 2009/0204359 A1
(43) Pub. Date: Aug. 13, 2009

(54) Method for determining the contributions of individual transmission paths

(75) Inventors: Robert Hoeldrich, Graz (AT); Alois Sontacchi, Gratwein (AT); Stephan Brandl, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL LIST GMBH

(21) Appl. No.: 12/320,789

(22) Filed: Feb. 4, 2009

(30) Foreign Application Priority Data
Feb. 8, 2008 (AT) A 210/2008

(51) Int. Cl. G06F 15/00; G01P 15/00

(52) U.S. Cl. 702/138; 702/141

(57) ABSTRACT

A method for determining the contributions of individual sound transmission paths to the operation-dependent total noise of a sound transmitting structure includes the following steps:
applying at least one acceleration sensor and/or source microphone in the area of each sound input position;
applying at least one target microphone and/or acceleration sensor in the area of a receiving position;
carrying out at least one simultaneous measurement of sound pressure and/or acceleration at the receiving position and of acceleration and/or sound pressure at each sound input position during operation;
determining at least one acceleration-to-pressure and/or acceleration-to-acceleration sensitivity function and/or at least one pressure-to-pressure sensitivity function;
determining reciprocally measured frequency response functions between each sound input position and each receiving position;
determining the inertances in the operational state for at least one sound input position;
determining of at least one force at at least one sound input position based on the computed inertances and the accelerations measured during operation at the sound input positions; and
determining the contributions of the individual transmission paths.

### BACKGROUND OF THE INVENTION

The invention relates to a method for determining the contributions of individual transmission paths to the total operation-dependent noise of a sound transmitting structure, in particular a vehicle.

Vibration or force input and transmission in a sound-transmitting structure, as for instance a vehicle body, is usually analyzed by a method known as “Transfer Path Analysis” (TPA). In this method the input inertances for certain force input points on the body and the transfer functions from these force input points to microphones in the vehicle interior and/or to vibration measuring points on the body are determined with the use of external excitation (shakers, hammers etc.). The effects of real excitations on the vehicle body during operation of the vehicle are determined by measuring accelerations at the force input points during operation and applying the previously determined inertances and transfer functions. The measurement of inertances and frequency response functions between sound input points and sound receiving points is one of the most time-consuming and error-prone tasks in the application of transfer path analysis. Accordingly it is eminently desirable to avoid the disadvantages of these time-consuming measurements.

### DESCRIPTION OF PRIOR ART

From AT 500.798 A2 there is known a method for highly accurate determination of forces at force input points of a vehicle body with regard to drive assembly and wheel suspension. From these forces and the vibration transfer characteristics of the vehicle body the noise and vibration contributions of the drive train and wheel suspension of the vehicle to cabin noise and vibration behavior of the body can be determined.

### SUMMARY OF THE INVENTION

It is the object of the present invention to avoid the above mentioned disadvantages and to propose a method for rapid and accurate computation of forces and of the contributions of individual transmission paths to total noise.

According to the invention this object is achieved by the following steps:
a) Defining at least one sound input position on the sound transmitting structure;
b) Applying at least one acceleration sensor and/or source microphone in the area of each sound input position;
c) Defining at least one receiving position;
d) Applying at least one target microphone and/or acceleration sensor in the area of the receiving position;
e) Carrying out at least one simultaneous measurement of sound pressure and/or acceleration at the receiving position and of acceleration and/or sound pressure at each sound input position during operation of the vehicle;
f) Determining at least one acceleration-to-pressure and/or acceleration-to-acceleration sensitivity function and/or at least one pressure-to-pressure sensitivity function based on the measurements carried out under e);
g) Determining reciprocally measured frequency response functions between each sound input position and each receiving position;
h) Determining the inertances in the operational state, for at least one sound input position, based on the reciprocally measured frequency response functions and acceleration-to-pressure or acceleration-to-acceleration sensitivity functions;
i) Determining of at least one force at at least one sound input position based on the computed inertances and the accelerations measured during operation at the sound input positions;
j) Determining the contributions of the individual trans-mission paths based on the computed forces and reciprocally measured frequency response functions and/or based on the pressure-to-pressure sensitivity functions and/or sound pressures measured during operation at the sound input positions.

According to the method of the invention inertances are computed based on at least one operative measurement in the operational state and immediately thereafter reciprocally measured frequency response functions between the sound source, i.e. the sound input position, and the target, i.e. the receiving position. The computed inertances may subsequently be used to assess the forces arising in the operational state. Knowledge of these forces permits determination and identification of the contributions of the respective sound sources to the sound pressure or acceleration at the receiving position.

A substantial improvement of the computed results is obtained if the excitation of all sources is taken into account by measuring accelerations or sound pressures near all defined sound input positions. Neglecting even one important sound source would lead to erroneous sensitivity functions and inertances. Additionally it is assumed that the acceleration-to-sound pressure respectively acceleration-to-acceleration sensitivity functions are time-invariant for all measurements in the operational state. Since positions and directions of the acceleration sensors are constant, the assumption implies that the temperature of the structure (e.g. the body of a vehicle) is to be kept as constant as possible for measurements in the operational state. Preheating the structure prior to measurement is therefore advantageous.

When sound transmission in air is present, the quality of the measurement results will improve if pressure-to-pressure or pressure-to-acceleration sensitivity functions are determined for the total air-borne sound between sound input positions and receiving positions, and if the contributions of air-borne sound to the total sound pressure or total acceleration at the receiving position is determined from pressure-to-pressure or pressure-to-acceleration sensitivity functions and the sound pressure measured during operation at the sound input positions, and if the contribution of air-borne sound is subtracted from the total sound pressure or the total acceleration at the receiving position.

In the embodiment of the invention it is provided that the acceleration-to-pressure and/or acceleration-to-acceleration sensitivity is determined for each receiving position and is taken into account in the computation of inertances.

An essential step of the method provides that a dynamical mass matrix is computed from the calculated inertances. This will subsequently permit computing the forces arising at the sound input positions during operation with the use of the mass matrix, and also determining the contributions of the individual sound transfer paths of all sources of structure-borne sound, based on the forces at the sound input positions during operation and the corresponding frequency response functions.

The method of the invention permits computation of inertances from measurements during operation and from the reciprocally measured frequency response functions between sound input position and receiving position. The advantages of the proposed new method are to be found in the significant reduction of time needed and in the avoidance of errors generally arising in the measurement of inertances or frequency responses. While the time-saving aspect of the method is obvious, the improvement in measurement quality will be further described in the following.

As mentioned above most errors in the context of transfer path analysis occur in the measurement of inertances and in the measurement of the frequency response function between source (sound input position, excitation position) and target (receiving position).

These errors are largely dependent on
deviations in the direction of excitation,
deviations from the position of excitation, and
differing temperatures of the structure at the time of inertance or frequency response measurement and at the time of measurement in the operational state.

The use of reciprocally measured frequency response functions will eliminate deviations in the direction of excitation since the force direction for the measured frequency response functions is identical with the measuring direction of the acceleration sensor. Furthermore, when measuring inertances and frequency response functions, it is easier to position an acceleration sensor near the origin of the excitation sources than to place a shaker or hammer at this site for external excitation. The error which is due to deviation from the sound input position, will thus be reduced by the present method.

The error due to temperature differences is reduced by reciprocal measurement if reciprocal measurement of the frequency response functions between sound input position and receiving position is carried out immediately after the operative measurement of sound pressure and sound acceleration. This will eliminate problems due to differing temperatures at the operative measurement and at the inertance or frequency response measurement.

The measurement method required for transfer path analysis as described, comprises one measurement in the operational state and a reciprocal measurement of frequency response functions between source and target. Measurements in the operational state may be carried out in the same way as conventional transfer path analysis measurements. Besides the reciprocally measured frequency response functions between the excitation position of the forces (positions of acceleration sensors) and the receiving positions, the method can also make use of the pressure-to-pressure or pressure-to-acceleration sensitivity function between source microphones and target microphones. For determination of these sensitivity functions any known method may be used.

After measurement has been performed the following frequency response functions and operational data are available;
Measurement in the operational state
   sound pressure respectively acceleration at the receiving positions during operation
   sound pressure at the source microphones during operation
   accelerations at the sound input positions during operation
   [optionally] pressure-to-pressure or pressure-to-acceleration sensitivity functions for total air-borne sound between sound sources and receiving positions.
Reciprocally measured frequency response functions
   frequency response functions from source positions to receiving positions.

### DETAILED DESCRIPTION OF THE INVENTION

The invention will now be explained in more detail with reference to an example.

To enable deeper understanding of the method of the invention a stepwise description of the theory will now be given. To reduce complexity the example below contains only receiving positions for air-borne sound in the cabin. Thus the computations involve only sound pressure and no accelerations at the receiving positions. Computation with accelerations could be carried out identically. If both accelerations and sound pressures at the receiving positions are to be used scaling of the matrices should be considered.

For more detailed explanation sound pressure pₜₒₜ at the target microphone may be split into a structure-borne component p_{SB} and an air-borne component p_{AB}, as shown in equation (1):

pₜₒₜ=p_{SB}+P_{AB} (1)
pₜₒₜ . . . total sound pressure
p_{SB} . . . structure-borne part of sound pressure
p_{AB} . . . air-borne part of sound pressure

Step 1.1—Determination of the Acceleration-to-Pressure Sensitivity S With Elimination of the Air-Borne Sound Component

If pressure-to-pressure sensitivities are known separation of the structure-borne sound component p_{SB} and the air-borne sound component p_{AB} can be carried out. Due to the fact that only total target sound pressure can be measured during operation and that the required inertances must be computed from the operational data, the air-borne sound components p_{AB} of the total sound pressure pₜₒₜ must be eliminated. To compute the air-borne sound component p_{AB} of the total sound pressure pₜₒₜ, the known pressure-to-pressure sensitivity functions are multiplied by the measured sound pressure at the corresponding source microphones. The computed air-borne sound components p_{AB} are then subtracted from the total target sound pressure level pₜₒₜ.

As mentioned above, it is assumed that the acceleration-to-pressure sensitivity function S of the given structure is time independent.

For computational reasons transformation from the time domain into the frequency domain is carried out using possibly overlapping short time-signal blocks. The suggested block size depends on the maximum length of the expected impulse responses of the sensitivities or frequency response functions to be determined. The selection of the position in time of the used signal blocks should be such that a high degree of statistical independence of the diverse signal blocks will be ensured.

Equation (2) is the resultant equation for a certain frequency f. For a given frequency f the second argument t represents the time-stamp of the diverse signal blocks (t=1, . . . ,m). To achieve reliable results the equation should be over-determined. The system may for instance be solved using singular value decomposition (SVD).

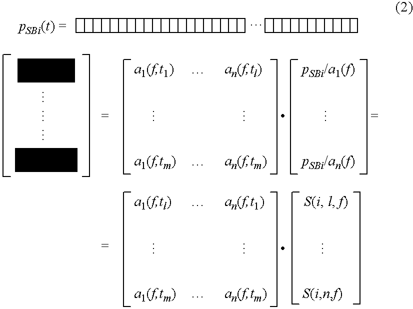

i . . . position of the response microphone
f . . . frequency under consideration
t₁ . . . tₘ . . . signal block under consideration
a₁ . . . aₙ . . . acceleration under consideration
S(i,j,f) . . . acceleration-to-sound pressure sensitivity for response microphone i and acceleration j at frequency f

Step 1.2—Determination of the Acceleration-to-Pressure Sensitivity S Without Elimination of the Air-Borne Sound Component (Alternatively to Step 1.1)

If pressure-to-pressure sensitivity is not known the sensitivities acceleration-to-pressure S and pressure-to-pressure can simultaneously be computed, alternatively to step 1.1. Computation of the required signals in the frequency domain can be carried out as in step 1.1. Besides the accelerations the sound pressures p_{S} at the source positions must be considered. The resulting equation (3) is shown below. To avoid errors arising from differences in scale between sound pressure and acceleration, the scale effect should be taken into account.

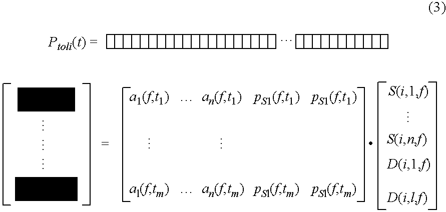

i . . . position of the response microphone
1 . . . m . . . time block under consideration
1 . . . n . . . accelerations under consideration
1 . . . I . . . source microphones under consideration
S(i,j,f) acceleration-to-sound pressure sensitivity for response microphone i and acceleration j at frequency f
p_{Sh} . . . sound pressure at source microphone h
D(i,h,f) sound pressure-to-sound pressure sensitivity for response microphone i and source microphone h at frequency f

Step 2—Determination of Inertances

After computation of acceleration-to-pressure sensitivities S,—as described in step 1.1 or in step 1.2 (depending on the availability of pressure-to-pressure sensitivities)—the required inertances, i.e. the quotients of acceleration amplitude and force, can be computed.

On account of the reciprocity rule the reciprocally measured frequency response function and the frequency response function in the operational state can be assumed to be equal. For determination of the inertances the reciprocally measured frequency response functions may therefore be compared with the frequency response functions given during operation. The corresponding equation is designated (4) and is to be read component wise.

$$\frac{{\vec{a}}_{rec}}{{\dot{Q}}_{i rec}} ( f ) ≡ \frac{{p}_{{i}_{op}}}{{\vec{F}}_{op}} ( f ) \qquad ( 4 )$$

\vec{a}_{rec} . . . accelerations during reciprocal measurement in direction Fₒₚ
\dot{Q}_{i rec} . . . volume acceleration during reciprocal measurement at the response microphone i
pᵢ_{ₒₚ} . . . sound pressure at response microphone i during operation
\vec{F}ₒₚ . . . vector of applied forces during operation

The frequency response functions effective in the operational state can generally be described by the relationship of equation (5). Besides the acceleration-to-pressure sensitivities S computed in step 1.1 or 1.2, equation (5) contains the inertances to be determined.

$$\frac{{p}_{{i}_{op}}}{{\vec{F}}_{op}} ( f ) = \frac{{p}_{{i}_{op}}}{{\vec{a}}_{op}} ( f ) \cdot \frac{{\vec{a}}_{op}}{{\vec{F}}_{op}} ( f ) \qquad ( 5 )$$

pᵢ_{ₒₚ} . . . sound pressure at the response microphone i during operation
\vec{a}ₒₚ . . . accelerations during operation
\vec{F}ₒₚ . . . vector of applied forces during operation

To compute the unknown inertances the frequency response functions of the operational state are replaced by the reciprocally measured frequency response functions as shown in equation (6).

$$\frac{{\vec{a}}_{rec}}{{\dot{Q}}_{i rec}} ( f ) ≡ \frac{{p}_{{i}_{op}}}{{\vec{a}}_{op}} ( f ) \cdot \frac{{\vec{a}}_{op}}{{\vec{F}}_{op}} ( f ) \qquad ( 6 )$$

\vec{a}_{rec} . . . accelerations in direction Fₒₚ during reciprocal measurement
\dot{Q}_{i r} . . . volume acceleration during reciprocal measurement at the response microphone i
pᵢ_{ₒₚ} . . . sound pressure at the response microphone i during operation
\vec{a}ₒₚ . . . accelerations in the operational state
\vec{F}ₒₚ . . . vector of applied forces in the operational state

Using equation (6) the inertances can be computed from the acceleration-to-pressure sensitivity S, determined in step 1.1 or step 1.2, and the reciprocally measured frequency response functions. The method may be applied for any number of degrees of freedom. Equation (7) gives an example of the application of the method for three forces and three accelerations (for instance excitation at a bearing).

$${[ \begin{matrix}\frac{{a}_{1 rec}}{{\dot{Q}}_{i rec}} ( f ) \\ \frac{{a}_{2 rec}}{{\dot{Q}}_{i rec}} ( f ) \\ \frac{{a}_{3 rec}}{{\dot{Q}}_{i rec}} ( f )\end{matrix} ]}^{T} = [ \begin{matrix}S ( i , 1 , f ) & S ( i , 2 , f ) & S ( i , 3 , f )\end{matrix} ] \cdot [ \begin{matrix}\frac{{a}_{11}}{{\vec{F}}_{1}} ( f ) & \frac{{a}_{12}}{{\vec{F}}_{2}} ( f ) & \frac{{a}_{13}}{{\vec{F}}_{3}} ( f ) \\ \frac{{a}_{21}}{{\vec{F}}_{1}} ( f ) & \frac{{a}_{22}}{{\vec{F}}_{2}} ( f ) & \frac{{a}_{23}}{{\vec{F}}_{3}} ( f ) \\ \frac{{a}_{31}}{{\vec{F}}_{1}} ( f ) & \frac{{a}_{32}}{{\vec{F}}_{2}} ( f ) & \frac{{a}_{33}}{{\vec{F}}_{3}} ( f )\end{matrix} ] = \begin{matrix}= [ S ( i , 1 , f ) & S ( i , 2 , f ) & S ( i , 3 , f ) ]\end{matrix} \cdot [ \begin{matrix}{I}_{11} ( f ) & {I}_{12} ( f ) & {I}_{13} ( f ) \\ {I}_{21} ( f ) & {I}_{22} ( f ) & {I}_{23} ( f ) \\ {I}_{31} ( f ) & {I}_{32} ( f ) & {I}_{33} ( f )\end{matrix} ] \qquad ( 7 )$$

\vec{F}ⱼ . . . force in direction i
aₖⱼ . . . acceleration in direction k caused by force j
Iₖⱼ . . . inertance between acceleration k and force j

In this case nine inertances have to be computed, and thus nine linear equations are required for uniquely determined results. To obtain this number of equations reciprocally measured frequency response functions at three target microphone positions i=1,2,3 must be obtained. The positions of the target microphones must be chosen such that the corresponding sound pressure signals are sufficiently statistically independent. Statistical independence is related to the wavenumber k and the distance r between the source microphone positions, with sin(kr)/kr≦0.5 being suggested. At a frequency of 100 Hz a distance of roughly 1 m between target microphones is required.

For each frequency f the inertances are listed as components of a vector, and a matrix containing the values of the acceleration-to-pressure sensitivity S is formed. The resulting relationship is exhibited in equation (8).

$${[ \begin{matrix}\frac{{a}_{1 rec}}{{\dot{Q}}_{1 rec}} ( f ) \\ \frac{{a}_{2 rec}}{{\dot{Q}}_{1 rec}} ( f ) \\ \frac{{a}_{3 rec}}{{\dot{Q}}_{1 rec}} ( f ) \\ \frac{{a}_{1 rec}}{{\dot{Q}}_{2 rec}} ( f ) \\ \frac{{a}_{2 rec}}{{\dot{Q}}_{2 rec}} ( f ) \\ \frac{{a}_{3 rec}}{{\dot{Q}}_{2 rec}} ( f ) \\ \frac{{a}_{1 rec}}{{\dot{Q}}_{3 rec}} ( f ) \\ \frac{{a}_{2 rec}}{{\dot{Q}}_{3 rec}} ( f ) \\ \frac{{a}_{3 rec}}{{\dot{Q}}_{3 rec}} ( f )\end{matrix} ]}^{T} = {[ \begin{matrix}{I}_{11} ( f ) \\ {I}_{12} ( f ) \\ {I}_{13} ( f ) \\ {I}_{21} ( f ) \\ {I}_{22} ( f ) \\ {I}_{23} ( f ) \\ {I}_{31} ( f ) \\ {I}_{32} ( f ) \\ {I}_{33} ( f )\end{matrix} ]}^{T} \cdot [ \begin{matrix}S ( 1 , 1 , f ) & 0 & 0 & S ( 2 , 1 , f ) & 0 & 0 & S ( 3 , 1 , f ) & 0 & 0 \\ 0 & S ( 1 , 1 , f ) & 0 & 0 & S ( 2 , 1 , f ) & 0 & 0 & S ( 3 , 1 , f ) & 0 \\ 0 & 0 & S ( 1 , 1 , f ) & 0 & 0 & S ( 2 , 1 , f ) & 0 & 0 & S ( 3 , 1 , f ) \\ S ( 1 , 2 , f ) & 0 & 0 & S ( 2 , 2 , f ) & 0 & 0 & S ( 3 , 2 , f ) & 0 & 0 \\ 0 & S ( 1 , 2 , f ) & 0 & 0 & S ( 2 , 2 , f ) & 0 & 0 & S ( 3 , 2 , f ) & 0 \\ 0 & 0 & S ( 1 , 2 , f ) & 0 & 0 & S ( 2 , 2 , f ) & 0 & 0 & S ( 3 , 2 , f ) \\ S ( 1 , 3 , f ) & 0 & 0 & S ( 2 , 3 , f ) & 0 & 0 & S ( 3 , 3 , f ) & 0 & 0 \\ 0 & S ( 1 , 3 , f ) & 0 & 0 & S ( 2 , 3 , f ) & 0 & 0 & S ( 3 , 3 , f ) & 0 \\ 0 & 0 & S ( 1 , 3 , f ) & 0 & 0 & S ( 2 , 3 , f ) & 0 & 0 & S ( 3 , 3 , f )\end{matrix} ] \qquad ( 8 )$$

In order to reduce the required number of target microphones the assumed symmetry of the inertance matrix may be utilized. Instead of M² inertances only M(M+1)/2 elements have to be computed. Equation (9) shows the formula used with the reduced set of inertances. The matrix of acceleration-to-pressure sensitivities for this equation is formed by summing two symmetrical inertances in a row.

$${[ \begin{matrix}\frac{{a}_{1 rec}}{{\dot{Q}}_{1 rec}} ( f ) \\ \frac{{a}_{2 rec}}{{\dot{Q}}_{1 rec}} ( f ) \\ \frac{{a}_{3 rec}}{{\dot{Q}}_{1 rec}} ( f ) \\ \frac{{a}_{1 rec}}{{\dot{Q}}_{2 rec}} ( f ) \\ \frac{{a}_{2 rec}}{{\dot{Q}}_{2 rec}} ( f ) \\ \frac{{a}_{3 rec}}{{\dot{Q}}_{2 rec}} ( f )\end{matrix} ]}^{T} = {[ \begin{matrix}{I}_{11} ( f ) \\ {I}_{12} ( f ) \\ {I}_{13} ( f ) \\ {I}_{22} ( f ) \\ {I}_{23} ( f ) \\ {I}_{33} ( f )\end{matrix} ]}^{T} \cdot [ \begin{matrix}S ( 1 , 1 , f ) & 0 & 0 & S ( 2 , 1 , f ) & 0 & 0 \\ S ( 1 , 2 , f ) & S ( 1 , 1 , f ) & 0 & S ( 2 , 2 , f ) & S ( 2 , 1 , f ) & 0 \\ S ( 1 , 3 , f ) & 0 & S ( 1 , 1 , f ) & S ( 2 , 3 , f ) & 0 & S ( 2 , 1 , f ) \\ 0 & S ( 1 , 2 , f ) & 0 & 0 & S ( 2 , 2 , f ) & 0 \\ 0 & S ( 1 , 3 , f ) & S ( 1 , 2 , f ) & 0 & S ( 2 , 3 , f ) & S ( 2 , 2 , f ) \\ 0 & 0 & S ( 1 , 3 , f ) & 0 & 0 & S ( 2 , 3 , f )\end{matrix} ] \qquad ( 9 )$$

After computation of inertances I a dynamical mass matrix can be obtained by inverting the inertance matrix. To determine the forces in the operational state the dynamical mass matrix must be multiplied by the accelerations in the operational state. Multiplication of the forces by the corresponding frequency response functions furnishes the contributions of all structure-borne-sound sources.

1. A method for determining the contributions of individual sound transmission paths to the operation-dependent total noise of a sound transmitting structure, especially a vehicle, comprising the following steps:
a) defining at least one sound input position on the sound transmitting structure;
b) applying at least one acceleration sensor and/or source microphone in the area of each sound input position;
c) defining at least one receiving position;
d) applying at least one target microphone and/or acceleration sensor in the area of the receiving position;
e) carrying out at least one simultaneous measurement of sound pressure and/or acceleration at the receiving position and of acceleration and/or sound pressure at each sound input position during operation of the vehicle;
f) determining at least one acceleration-to-pressure and/or acceleration-to-acceleration sensitivity function and/or at least one pressure-to-pressure sensitivity function based on the measurements carried out in step e);
g) determining reciprocally measured frequency response functions between each sound input position and each receiving position;
h) determining the inertances in the operational state, for at least one sound input position, based on the reciprocally measured frequency response functions and the acceleration-to-pressure or the acceleration-to-acceleration sensitivity functions;
i) determining of at least one force at at least one sound input position based on the computed inertances and the accelerations measured during operation at the sound input positions; and
j) determining the contributions of the individual transmission paths based on the computed forces and the reciprocally measured frequency response functions and/or based on the pressure-to-pressure sensitivity functions and/or the sound pressures measured during operation at the sound input positions.

2. The Method according to claim 1, wherein step g) is carried out immediately after steps e) and f).

3. The method according to claim 1, wherein at least one pressure-to-pressure sensitivity function and/or pressure-to-acceleration sensitivity function is determined for total air-borne sound between the sound input position and the receiving position.

4. The method according to claim 3, wherein the air-borne sound component and/or acceleration component of total sound pressure or total acceleration at the receiving position is determined using the given pressure-to-pressure sensitivity function and/or pressure-to-acceleration sensitivity function and the measured sound pressure at the sound input position, and subtracting the air-borne sound or acceleration component from total sound pressure or total acceleration at the receiving position.

5. The method according to claim 1, wherein—in case no pressure-to-pressure or pressure-to-acceleration sensitivity function is given for airborne sound transmission between sound input position and receiving position—the pressure-to-pressure sensitivity function or the pressure-to-acceleration sensitivity function is determined together with the acceleration-to-sound pressure or acceleration-to-acceleration sensitivity function.

6. The method according to claim 1, wherein the acceleration-to-pressure sensitivity and/or acceleration-to-acceleration sensitivity is determined for each receiving position and used in the computation of inertances.

7. The method according to claim 1, wherein a dynamical mass matrix is computed based on the inertances determined.

8. The method according to claim 7, wherein the forces arising at the sound input positions in the operational state are computed based on the dynamical mass matrix.

9. The method according to claim 8, wherein the contributions of the individual transmission paths of all structure-borne-sound sources are determined based on the forces at the sound input positions in the operational state and on corresponding frequency response functions.
